(19) United States
(12) Patent Application Publication
(10) Pub. No.: US 2025/0210039 A1
(43) Pub. Date: Jun. 26, 2025

(54) VOICE ASSIST SYSTEM AND METHOD

(71) Applicant: GM Global Technology Operations LLC, Detroit, MI (US)

(72) Inventor: Wenyuan Qi, Shanghai (CN)

(21) Appl. No.: 18/409,077

(22) Filed: Jan. 10, 2024

(30) Foreign Application Priority Data
Dec. 26, 2023 (CN) 2023118139357

(51) Int. Cl. G10L 15/22; G10L 15/16; G10L 19/00; G10L 21/0208

(52) U.S. Cl. CPC G10L 15/22; G10L 15/16; G10L 19/00; G10L 21/0208; G10L 2015/223

(57) ABSTRACT

A method for voice assistance includes receiving, by a vehicle controller of a vehicle, audio data. The audio data is indicative of a voice command uttered by a user of the vehicle in natural language. The method also includes encoding, using an encoder of a variational autoencoder, the audio data into a latent space to generate encoded data. The method also includes receiving contextual data relating to the voice command uttered by the user of the vehicle. The method also includes generating, using a decoder of the variational autoencoder, an expression from the encoded data and the contextual data. The expression is representative of the audio data. The method also includes commanding, using the vehicle controller, the vehicle to generate a response based on the expression generated by the decoder of the variational autoencoder.

### INTRODUCTION

The present disclosure relates to voice assist systems and methods. More particularly, the present disclosure relates to voice assist systems and methods in vehicles.

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Tokenization-based sentence generation and context understanding for voice recognition has quite a number of constraints and limitations. For example, a homophone token may introduce ambiguities into the voice recognition process. For this reason, it is desirable to develop voice assist methods and systems that don't rely on tokenization.

### SUMMARY

The present disclosure describes a voice assist method. The method includes receiving, by a vehicle controller of a vehicle, audio data. The audio data is indicative of a voice command uttered by a user of the vehicle in natural language. The method also includes encoding, using an encoder of a variational autoencoder, the audio data into a latent space to generate encoded data. The method also includes receiving contextual data relating to the voice command uttered by the user of the vehicle. The method also includes generating, using a decoder of the variational autoencoder, an expression from the encoded data and the contextual data. The expression is representative of the audio data. The method also includes commanding, using the vehicle controller, the vehicle to generate a response based on the expression generated by the decoder of the variational autoencoder. The method described in this paragraph improves voice recognition technology and vehicle technology by recognizing natural language uttered by a user without relying on lexical tokenization, which is prone to error when user utters language-specific traditional expressions (e.g., idioms, poems, slang, etc.). Because the method described in this paragraph does not use lexical tokenization, this method improves natural language recognition by voice assist applications, thus improving voice recognition technology and voice assist applications in vehicles.

In certain aspects of the present disclosure, the method does not include executing lexical tokenization of the audio data. The method may include reducing a background noise from the audio data and recognizing a voice in the audio data. The encoder of the variational autoencoder is a first neural network that maps the audio data into the latent space. The audio data is in an input space. The decoder is a second neural network that maps the encoded data into the input space. The contextual data may use contextual data as an input. The contextual data includes user voice data and external factors data. The user voice data includes information about a voice tone of the user while the user utters the voice command. The external factors data includes traffic condition around the vehicle when the user uttered the voice command, a date when the user uttered the voice command, and a time when the user uttered the voice command. The contextual data includes conversational history data. The conversation history data includes information about the conversational history of the user that uttered the voice command. The contextual data serves as an input of the second neural network. The response is generated based on a plurality of constraints. The plurality of constraints includes response time and sentence length. The method may include controlling an actuator of the vehicle based on the response.

The present disclosure further describes a voice assist system. The voice assist system includes a user interface including a microphone. The microphone is configured to capture a voice command uttered by a user of a vehicle. The voice assist system further includes a plurality of sensors. Each of the plurality of sensor is configured to collect contextual data. The voice assist system further includes a vehicle controller in communication with the user interface and the plurality of sensors. The vehicle controller is programmed to execute the method described above.

The present disclosure also describes a tangible, non-transitory, machine-readable medium, comprising machine-readable instructions, that when executed by a processor, cause the processor to execute the method described above.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic diagram of a vehicle including a voice assist system.

FIG. 2 is a flowchart of a voice assist method.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps.

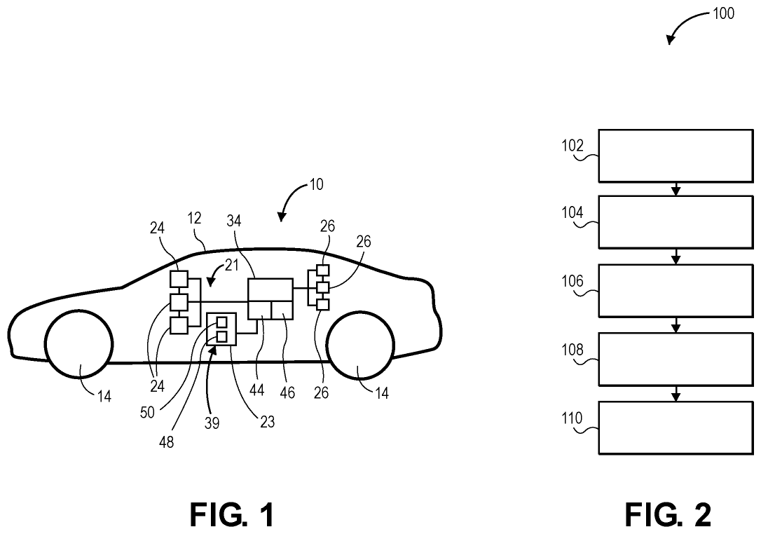

With reference to FIG. 1, a vehicle 10 includes a voice assist system 39. The vehicle 10 generally includes a body 12 and a plurality of wheels 14 coupled to the body 12. The vehicle 10 may be an autonomous vehicle. In the depicted embodiment, the vehicle 10 is depicted in the illustrated embodiment as a sedan, but it should be appreciated that other vehicles including trucks, coupes, sport utility vehicles (SUVs), boats, airplanes, recreational vehicles (RVs), etc., may also be used.

The vehicle 10 further includes one or more sensors 24 coupled to the body 12. The sensors 24 sense observable conditions of the exterior environment and/or the interior environment of the vehicle 10. As non-limiting examples, the sensors 24 may include one or more cameras, one or more light detection and ranging (LIDAR) sensors, one or more proximity sensors, one or more ultrasonic sensors, one or more thermal imaging sensors, Global Positioning System (GPS) transceivers, and/or other sensors. Each sensor 24 is configured to generate a signal that is indicative of the sensed observable conditions (i.e., sensor data) of the exterior environment and/or the interior environment of the vehicle 10. The signal is indicative of the sensor data collected by the sensors 24.

The vehicle 10 includes a vehicle controller 34 in communication with the sensors 24. The vehicle controller 34 includes at least one vehicle processor 44 and a vehicle non-transitory computer readable storage device or media 46. The vehicle processor 44 may be a custom made or commercially available processor, a central processing unit (CPU), a graphics processing unit (GPU), an auxiliary processor among several processors associated with the vehicle controller 34, a semiconductor-based microprocessor (in the form of a microchip or chip set), a macroprocessor, a combination thereof, or generally a device for executing instructions. The vehicle readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the vehicle processor 44 is powered down. The vehicle computer-readable storage device or media 46 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the vehicle controller 34 in controlling the vehicle 10. The vehicle controller 34 is specifically programmed to execute the method 100 (FIG. 2) as described in detail below.

The instructions may include one or more separate programs, each of which comprises an ordered listing of executable instructions for implementing logical functions. The instructions, when executed by the vehicle processor 44, receive and process signals from sensors, perform logic, calculations, methods and/or algorithms for automatically controlling the components of the vehicle 10, and generate control signals to automatically control the components of the vehicle 10 based on the logic, calculations, methods, and/or algorithms. Although a single vehicle controller 34 is shown in FIG. 1, embodiments of the vehicle 10 may include a plurality of vehicle controllers 34 that communicate over a suitable communication medium or a combination of communication mediums and that cooperate to process the sensor signals, perform logic, calculations, methods, and/or algorithms, and generate control signals to automatically control features of the vehicle 10. The vehicle controller 34 is part of the voice assist system 39.

The vehicle 10 further includes one or more actuators 26 in communication with the vehicle controller 34. The actuators 26 control one or more vehicle features such as, but not limited to, the propulsion system, the transmission system, the steering system, radio, air-conditioning system, and the brake system of the vehicle 10. In various embodiments, the vehicle features may further include interior and/or exterior vehicle features such as, but are not limited to, doors, a trunk, and cabin features such as air, music, lighting, etc.

The vehicle 10 includes a user interface 23 in communication with the vehicle controller 34. The user interface 23 may be a touchscreen in the dashboard. The user interface 23 may include, but is not limited to, an alarm, such as one or more speakers 48 to provide an audible sound, haptic feedback in a vehicle seat or other object, one or more displays, one or more microphones 50 (e.g., a microphone array) and/or other devices suitable to provide a notification to the vehicle user of the vehicle 10. The microphones 50 are configured to capture voice commands by a user of the vehicle 10. The user interface 23 is in electronic communication with the vehicle controller 34 and is configured to receive inputs by a vehicle occupant (e.g., a vehicle operator or a vehicle passenger), such as voice commands. For example, the user interface 23 may include a touch screen and/or buttons configured to receive inputs from a person.

As discussed below, the voice assist system 39 uses a generative model (e.g., variational autoencoder). As discussed above, the encoder of the variational autoencoder encodes audio data collected by the microphones 50 into a latent space in order to search and build up the most relevant information for understanding the natural language uttered by the user of the vehicle 10. The variational autoencoder also uses contextual data and external factors data to maximize the accuracy of the natural language conversion from the user's utterance to a digital audio signal. In doing so, the voice assist system 39 can also understand language-specific traditional expressions (e.g., poems, idioms, slang, or other colloquialisms) by taking into consideration the external and contextual factors. Because the voice assist system 39 considers external and contextual factors, there is no need to translate the source language into standard English and then translate back into the source language. As a result, the voice assist system 39 accurately converts user's utterances into digital audio form. Further, the voice assist system 39 does not rely on lexical tokenization. Tokenization-based sentence generation and context understanding for voice recognition has quite a number of constraints and limitations. For example, a homophone token may introduce ambiguities into the voice recognition process. Consequently, the voice assist system 39 accurately converts user's utterances into digital audio form.

FIG. 2 is a flowchart of a voice assist method 100. The method 100 does not use lexical tokenization and begins at block 102. At block 102, the vehicle controller 34 receives audio data collected by the microphones 50. The audio data is indicative of a voice command uttered by a user of the vehicle 10 in natural language. Moreover, at block 102, the vehicle controller 34 reduces the background noise from the audio data and recognizing the user's voice in the audio data. As a non-limiting example, a dual-ended compander noise reduction system may be used to reduce the background noise from the audio data. A suitable automatic speech recognition (ASR) system may be used to recognize the user's voice in the audio data collected by the microphones 50. In this method 100, the voice assist system 39 is always listening. Accordingly, the noise reduction is performed iteratively every cycle of the voice assist (e.g., every 1 millisecond). Then, the method 100 continues to block 104.

At block 104, the vehicle controller 34 encodes the audio data collected by the microphones 50 into a latent space using an encoder of a variational autoencoder. Therefore, the audio data serves as an input of the encoder. Encoding the audio data generates encoded data, which is compressed data. The audio data is in an input space. The latent space is a lower-dimensional space relative to the input space to minimize the burden of voice conversion from the user's voice utterance to a digital wave form. The encoder of the variational autoencoder is a first neural network that maps the audio into the latent space. In other words, the encoder of the variational autoencoder encodes the voice wave signal into latent variables and vectors. This encoder of the variational autoencoder has been previously trained to cover multiple situations. For instance, the encoder is trained to recognize homophone voices and their meanings. One voice and one voice may have multiple meanings. In the method 100, the voice assist system 39 introduces a third language to do the cross reference for better meaning mapping. The encoder of the variational autoencoder is adaptable and, therefore, the tracks voices in different dialects by using latent variables and vectors. Further, the encoder of the variational autoencoder recognizes language-specific traditional expressions (e.g., idioms, poems, slang, etc.) by using the contextual data. The contextual data may include conversational history data about the user. The conversation history data includes information about the conversational history of the user that uttered the voice command. Therefore, in addition to the audio data, the contextual data may be an input of the first neural network that forms the encoder of the variational autoencoder. In the words, the audio data and the contextual data may be inputs of the first neural network that forms the encoder of the variational autoencoder. The voice assist system 39 also recognizes and understands sounds that, despite having no words, have meaning. Then, the method 100 continues to block 106.

At block 106, the vehicle controller 34 understands the context based on the encoded data. Specifically, the vehicle controller 34 receives contextual data relating to the voice command uttered by the user of the vehicle from, for example, the sensors 24. The contextual data in is the latent space and has no explicit language-based meaning. The contextual data includes user voice data. In turn, the user voice data includes information about a voice tone and the mood of the user while the user utters the voice command. The contextual data may also include external factors data. The external factors data includes traffic condition around the vehicle 10 when the user uttered the voice command, a date when the user uttered the voice command, and a time when the user uttered the voice command, among other things. The contextual data may also include conversational history data. The conversation history data includes information about the conversational history of the user that uttered the voice command to help understand a language-based traditional expression. The method 100 then continues to block 108.

At block 108, the vehicle controller 34 generates an expression (in voice wave format) from the encoded data and the contextual data using a pretrained decoder of the variational autoencoder. The expression is representative of the audio data collected by the microphones 50. The decoder is a second neural network that maps the encoded data into the input space. The decoder may be trained using the audio data and the contextual data from the vehicle 10. The decoder creates a poll of all the contexts and parallelly generates all the possible responses in real time. Some unlikely responses may be filtered out by considering the voice tone, context, and preference, thereby enhancing the accuracy of the decoder. Then, the method 100 proceeds to block 110.

At block 110, the vehicle controller 34 commands the vehicle to generate a response based on the expression generated by the decoder of the variational autoencoder. The response has some constraints (e.g., response time, sentence length, tone, etc.) in order to make the response as natural as possible according to the user's preferences and characteristics. The voice assist system 39 may proactively generate the responses even when no voice information is captured. The vehicle controller 34 may command the speakers 49 to voice the responses. Additionally, the vehicle controller 34 may control one or more actuators 26 to control one or more vehicle operations (e.g., air-conditioning system, text messaging, music, shopping, anxiety relief, switch to autopilot mode, etc.) automatically upon confirmation by the user. The response may also provide an explanation of the decision made when the vehicle 10 is in auto-pilot mode.

The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

Embodiments of the present disclosure are described herein. It is to be understood, however, that the disclosed embodiments are merely examples and other embodiments can take various and alternative forms. The figures are not necessarily to scale; some features could be exaggerated or minimized to display details of particular components. Therefore, specific structural and functional details disclosed herein are not to be interpreted as limiting, but merely as a representative basis for teaching one skilled in the art to variously employ the presently disclosed system and method. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure may be described herein in terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A voice assist method, comprising:
receiving, by a vehicle controller of a vehicle, audio data, wherein the audio data is indicative of a voice command uttered by a user of the vehicle in natural language;
encoding, using an encoder of a variational autoencoder, the audio data into a latent space to generate encoded data;
receiving contextual data relating to the voice command uttered by the user of the vehicle;
generating, using a decoder of the variational autoencoder, an expression from the encoded data and the contextual data, wherein the expression is representative of the audio data; and
commanding, using the vehicle controller, the vehicle to generate a response based on the expression generated by the decoder of the variational autoencoder.

2. The method of claim 1, wherein the method does not include executing lexical tokenization of the audio data.

3. The method of claim 2, further comprising:
reducing a background noise from the audio data; and
recognizing a voice in the audio data.

4. The method of claim 3, wherein the encoder of the variational autoencoder is a first neural network that maps the audio data into the latent space, the audio data is in an input space, and the decoder is a second neural network that maps the encoded data into the input space, the contextual data includes user voice data, and the user voice data includes information about a voice tone of the user while the user utters the voice command.

5. The method of claim 4, wherein the contextual data includes external factors data, wherein the external factors data includes traffic condition around the vehicle when the user uttered the voice command, a date when the user uttered the voice command, and a time when the user uttered the voice command.

6. The method of claim 5, wherein the contextual data includes conversational history data, wherein the conversation history data includes information about a conversational history of the user that uttered the voice command.

7. The method of claim 6, wherein the contextual data serves as an input of the second neural network.

8. The method of claim 7, wherein the response is generated based on a plurality of constraints.

9. The method of claim 8, wherein the plurality of constraints includes response time and sentence length.

10. The method of claim 9, wherein the response includes controlling an actuator of the vehicle based on the response.

11. A voice assist system, comprising:
a user interface including a microphone, wherein the microphone is configured to capture a voice command uttered by a user of a vehicle;
a plurality of sensors, wherein each of the plurality of sensor is configured to collect contextual data;
a vehicle controller in communication with the user interface and the plurality of sensors, wherein the vehicle controller is programmed to:
receive audio data, wherein the audio data is indicative of the voice command uttered by the user of the vehicle in natural language;
encode, using an encoder of a variational autoencoder, the audio data into a latent space to generate encoded data;
receive contextual data relating to the voice command uttered by the user of the vehicle;
generate, using a decoder of the variational autoencoder, an expression from the encoded data and the contextual data, wherein the expression is representative of the audio data; and
command the vehicle to generate a response based on the expression generated by the decoder of the variational autoencoder.

12. The system of claim 11, wherein the vehicle controller is programmed to refrain from performing lexical tokenization of the audio data.

13. The system of claim 12, wherein the vehicle controller is programmed to:
reduce a background noise from the audio data; and
recognize a voice in the audio data.

14. The system of claim 13, wherein the encoder of the variational autoencoder is a first neural network that maps the audio data into the latent space, the audio data is in an input space, and the decoder is a second neural network that maps the encoded data into the input space, the contextual data includes user voice data, and the user voice data includes information about a voice tone of the user while the user utters the voice command.

15. The system of claim 14, wherein the contextual data includes external factors data, wherein the external factors data includes traffic condition around the vehicle when the user uttered the voice command, a date when the user uttered the voice command, and a time when the user uttered the voice command.

16. The system of claim 15, wherein the contextual data includes conversational history data, wherein the conversation history data includes information about a conversational history of the user that uttered the voice command.

17. The system of claim 16, wherein the contextual data serves as an input of the second neural network.

18. The system of claim 17, wherein the response is generated based on a plurality of constraints.

19. The system of claim 18, wherein the plurality of constraints includes response time and sentence length.

20. The system of claim 19, further comprising controlling an actuator of the vehicle based on the response.
